(19) United States
(12) Patent Application Publication
(10) Pub. No.: US 2024/0375044 A1
(43) Pub. Date: Nov. 14, 2024

(54) A DESICCANT DEHUMIDIFIER

(71) Applicant: MUNTERS EUROPE AKTIEBOLAG, Kista (SE)

(72) Inventor: Urban Gunnarsson, Tierp (SE)

(21) Appl. No.: 18/684,614

(22) PCT Filed: Jun. 23, 2022
(86) PCT No.: PCT/EP2022/067229

§ 371 Date: Feb. 16, 2024

(30) Foreign Application Priority Data
Aug. 23, 2021 (SE) 2151015-1

(51) Int. Cl. B01D 53/26; B01D 53/06; F24F 3/14

(52) U.S. Cl. CPC B01D 53/261; B01D 53/06; F24F 3/1423; B01D 2257/80; B01D 2258/06; B01D 2259/40086; F24F 2003/1464; F24F 2203/1032

(57) ABSTRACT

A desiccant dehumidifier includes a desiccant rotor, which is rotatably arranged about a center axis; a process air circuit arranged to conduct a process airflow through a process sector of the desiccant rotor; a regeneration air circuit arranged to conduct a regeneration airflow through a regeneration sector of the desiccant rotor; a purge air circuit arranged to conduct a purge airflow through a first purge sector and a second purge sector of the desiccant rotor; and an air fan arranged downstream of the desiccant rotor, which air fan is configured to generate the regeneration airflow in the regeneration air circuit and the purge airflow in the purge air circuit. The purge air circuit is arranged to conduct the purge airflow through the first purge sector in a first direction through the desiccant rotor, and through the second purge sector in a second direction through the desiccant rotor, wherein the first direction is opposite to the second direction.

### TECHNICAL FIELD

The present disclosure relates to a desiccant dehumidifier comprising a desiccant wheel.

### BACKGROUND ART

Dehumidifiers, such as sorption dehumidifiers and condensate dehumidifiers, are used for separating and removing moisture from air. A sorption dehumidifier typically comprises a dehumidifying element in the form of a wheel or rotor holding desiccant material, which is effective in attracting and retaining water vapour. The dehumidifier may comprise two sections for the desiccant rotor, a process section and a regeneration section. The airflow to be dehumidified, process air, will pass through the process section and pass through the desiccant rotor. The desiccant material in the rotor extracts moisture from the process air, so that it can leave the rotor as dried air. Simultaneously, the desiccant material is regenerated by a regeneration air flow, which flows through the regeneration section, all the while the desiccant rotor may rotate slowly about its centre axis. An air fan may be configured to generate the regeneration airflow through the regeneration section. By means of the simultaneous dehumidification of the process air and regeneration of desiccant material, the dehumidifier can be operated continuously.

Document US2007056307 discloses an example of a dehumidifier having a desiccant wheel.

For the regeneration process to be effective, the air stream used for regeneration of the desiccant material in the rotor needs to have a relatively high temperature, and will typically need to be heated. There is an ongoing interest in minimising the energy consumption of the dehumidification process, for economic reasons and for consideration of climate aspects, and in obtaining stable operation of the dehumidification unit.

An even more effective regeneration process may be achieved if an additional air stream, a purge air stream, is used for regeneration of the desiccant material in the rotor.

### SUMMARY OF THE INVENTION

The dehumidifying capacity of a dehumidifier can generally be changed by reducing or increasing the process air stream and/or increasing the regeneration energy. Further, separate sectors for the desiccant rotor are able to increasing the dehumidifying capacity, achieving very low dew points, resulting in dry process air, and saving heating energy by heat recovery and changes of the temperature of the rotor material. By means of the purge sector, low dry air dew points and reduction of heater energy of the regeneration air stream are achieved. Further, by using only one air fan for generating the regeneration airflow through the regeneration section and also for generating the purge air stream through the purge sector, reduced electrical energy for operating the air fan is achieved.

Despite known solutions in the field, it would be desirable to develop a desiccant dehumidifier, which overcomes or alleviates at least some of the drawbacks of the prior art.

An objective of the present invention is to achieve a desiccant dehumidifier, which allows for energy efficiency.

A further objective of the present invention is to achieve a desiccant dehumidifier, which allows for a stable, reliable and effective treatment of air, and thereby improves the functionality/performance of the desiccant dehumidifier.

These objectives are achieved with the above-mentioned desiccant dehumidifier according to the appended claims.

According to an aspect of the invention, a desiccant dehumidifier is provided. The desiccant dehumidifier comprising: a desiccant rotor, which is rotatably arranged about a centre axis of the desiccant rotor; a process air circuit arranged to conduct a process airflow through a process sector of the desiccant rotor; a regeneration air circuit arranged to conduct a regeneration airflow through a regeneration sector of the desiccant rotor; a purge air circuit arranged to conduct a purge airflow through a first purge sector and a second purge sector of the desiccant rotor; an air fan arranged downstream of the desiccant rotor, which air fan is configured to generate the regeneration airflow in the regeneration air circuit and the purge airflow in the purge air circuit, characterized in that the purge air circuit is arranged to conduct the purge airflow through the first purge sector in a first direction through the desiccant rotor, and through the second purge sector in a second direction through the desiccant rotor, wherein the first direction is opposite to the second direction.

An advantage of the invention is that the desiccant dehumidifier allows for only one air fan for generating both the regeneration airflow and the purge airflow. This will be possible when the first direction of the purge airflow through the first purge sector is opposite to the second direction of the purge airflow through the second purge sector. This will allow for energy efficiency and will also improve the functionality and performance of the desiccant dehumidifier due to only one air fan for generating the regeneration airflow and the purge airflow.

Additional objectives, advantages and novel features of the invention will be apparent to one skilled in the art from the following details, and through exercising the invention. While the invention is described below, it should be apparent that the invention may not be limited to the specifically described details. One skilled in the art, having access to the teachings herein, will recognize additional applications, modifications and incorporations in other areas, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various figures, and in which:

FIG. 1 schematically illustrates a view in perspective of a desiccant dehumidifier according to an example,

FIG. 2 schematically illustrates a desiccant dehumidifier according to an example, and

FIG. 3 schematically illustrate a desiccant rotor according to an example.

### DETAILED DESCRIPTION

The detailed description with reference to the examples depicted are to be viewed as examples comprising a combination of certain features, which features have been described in detail above. It is thus to be understood that additional examples may be achieved by combining other features into examples not depicted herein. The figures are to be viewed as examples and not mutually exclusive combinations. It should also be noted that all figures shown and described are schematically represented, wherein generic parts of machinery or similar is not depicted for the sake of simplicity.

According to an aspect of the present disclosure, a desiccant dehumidifier is provided. The desiccant dehumidifier comprising: a desiccant rotor, which is rotatably arranged about a centre axis of the desiccant rotor; a process air circuit arranged to conduct a process airflow through a process sector of the desiccant rotor; a regeneration air circuit arranged to conduct a regeneration airflow through a regeneration sector of the desiccant rotor; a purge air circuit arranged to conduct a purge airflow through a first purge sector and a second purge sector of the desiccant rotor; an air fan arranged downstream of the desiccant rotor, which air fan is configured to generate the regeneration airflow in the regeneration air circuit and the purge airflow in the purge air circuit, characterized in that the purge air circuit is arranged to conduct the purge airflow through the first purge sector in a first direction through the desiccant rotor, and through the second purge sector in a second direction through the desiccant rotor, wherein the first direction is opposite to the second direction.

The desiccant dehumidifier is configured to treat air in order to separate and remove moisture, such as water vapour from the air. Dry air may be conveyed from the desiccant dehumidifier to a space or a room in which the humidity in the air should be controlled.

The desiccant rotor holding desiccant material, which is effective in attracting and retaining water vapour. The process airflow will flow in the process air circuit and pass through the desiccant rotor. Desiccant material in the main desiccant rotor extracts moisture from the process air in the process airflow, so that the process air can leave the desiccant rotor as dried air. The extracted moisture from the process air is removed from the desiccant material in the desiccant rotor by the regeneration airflow, which flows in the regeneration air circuit and through the desiccant rotor. The removed moisture from the desiccant material is conveyed from the desiccant rotor by the regeneration airflow in the regeneration air circuit downstream of the desiccant rotor. The air fan, which is arranged downstream of the desiccant rotor, is configured to generate the regeneration airflow in the regeneration air circuit.

In addition to the process airflow and the regeneration airflow also a purge airflow is configured to pass through the desiccant rotor. The purge airflow is arranged to flow in a purge air circuit of the desiccant dehumidifier. The purge air circuit is arranged to conduct the purge airflow through the first purge sector and the second purge sector of the desiccant rotor. Thus, desiccant dehumidifier comprises four sections for the desiccant rotor. The four sections are the process section, the regeneration section, the first purge section and the second purge section. The temperature of the desiccant rotor will increase when the regeneration airflow passes through the rotor. In order to effectively trap moist and water from the process airflow in the desiccant rotor, there is an ambition to decrease the temperature of that part of the desiccant rotor in which the regeneration airflow passes through the desiccant rotor. Therefore, the purge airflow is directed through the first purge sector. The purge airflow flowing through the first purge sector may have a temperature which is lower than the temperature of the regeneration airflow passing through the desiccant rotor. Thus, the purge airflow flowing through the first purge sector will decrease the temperature of that part or section of the desiccant rotor in which the regeneration airflow has passed through the desiccant rotor. Due to the increased temperature of the desiccant rotor by the regeneration airflow, the temperature of the air in the purge airflow will increase when it flows through the first purge sector.

After the purge airflow has passed through the first purge sector, the purge airflow is directed through the second purge sector. Since the temperature of the air in the purge airflow has increased after passing through the first purge sector, the purge airflow will increase the desiccant rotor when it passes through the second purge sector.

During rotation of the desiccant rotor about the centre axis the desiccant rotor continuously passing the process sector, first purge sector, the regeneration sector and the second purge sector.

The purge air circuit is arranged to conduct the purge airflow through the first purge sector in a first direction through the desiccant rotor, and through the second purge sector in a second direction through the desiccant rotor, wherein the first direction is opposite to the second direction. The air fan generates a vacuum in the regeneration air circuit and in the purge air circuit, which vacuum will generate both the regeneration air flow and the purge airflow.

The desiccant dehumidifier allows for only one air fan for generating both the regeneration airflow and the purge airflow. This will be possible when the first direction of the purge airflow through the first purge sector is opposite to the second direction of the purge airflow through the second purge sector. This will allow for energy efficiency and will also improve the functionality and performance of the desiccant dehumidifier due to only one air fan for generating the regeneration airflow and the purge airflow.

According to an aspect, the purge air circuit is connected to the regeneration air circuit downstream of the desiccant rotor. This will result in that the air fan may be physically connected to the regeneration air circuit downstream of the desiccant rotor. The vacuum in the regeneration air circuit generated by the air fan will also generate vacuum in the purge air circuit. Only one air fan generating both the regeneration air flow and the purge airflow will allow for energy efficiency and will also improve the functionality and performance of the desiccant dehumidifier.

According to an aspect, the purge air circuit is connected to the regeneration air circuit upstream of the desiccant rotor, and wherein the purge airflow is configured to be collected from the regeneration airflow in the regeneration air circuit. This configuration may result in only one inlet for air to the purge air circuit and to the regeneration air circuit. This may facilitate the design of the desiccant dehumidifier.

According to an aspect, a heater device is arranged in connection to the regeneration air circuit upstream of the desiccant rotor and downstream of a position where the purge air circuit is connected to the regeneration air circuit. This heater device is configured to increase the temperature of the regeneration air in the regeneration air circuit. Since the heater device is arranged downstream of the position where the purge air circuit is connected to the regeneration air circuit, the purge air will not be heated by the heater device. Instead the purge airflow flowing through the first purge sector may decrease the temperature of that part or section of the desiccant rotor in which the regeneration airflow has passed through the desiccant rotor.

According to an aspect, the first purge sector is arranged adjacent to the regeneration sector on a first side of the regeneration sector, and the second purge sector is arranged adjacent to the regeneration sector on a second side of the regeneration sector. This configuration of the sectors results in that the purge airflow flowing through the first purge sector will decrease the temperature of that part or section of the desiccant rotor in which the regeneration airflow has passed through the desiccant rotor. Further, the purge airflow will increase the desiccant rotor when it passes through the second purge sector.

According to an aspect, the ratio between a regeneration sector angle of the regeneration sector and the sum of a first purge sector angle and a second purge sector angle of the respective first and second purge sector is selected such that both the regeneration airflow and the purge airflow are generated. Since both the regeneration airflow and the purge airflow are generated by the common air fan, the pressure drop through the sectors may be affected by the relation between the area of the sectors. By selecting suitable sector angels according to above, the pressure drop through the sectors may be of an amount such that both the regeneration airflow and the purge airflow are generated. Such a selection of the ratio may also take the design of channels, pipes and connections for the conveying of the regeneration airflow and the purge airflow to the desiccant rotor into consideration. There may be different pressure drop through the different channels, pipes and connections.

According to an aspect, the ratio between a regeneration sector angle of the regeneration sector and the sum of a first purge sector angle and a second purge sector angle of the respective first and second purge sector is in the range of 1:1-1.5:1. A ratio within this range may generate an effective purge airflow through the respective first and second purge sectors.

According to an aspect, the ratio between a regeneration sector angle of the regeneration sector and the sum of a first purge sector angle and a second purge sector angle of the respective first and second purge sector is in the range of 1:1-1.25:1. A ratio within this range may generate an effective purge airflow through the respective first and second purge sectors.

According to an aspect, the regeneration sector angle of the regeneration sector is equal to the sum of a first purge sector angle and a second purge sector angle of the respective first and second purge sector. The sum of the first and second purge sector angles may be equal to the regeneration sector angle. This may result in that the area of the regeneration sector is equal to the sum of the areas of the first and second purge sectors. This may generate an effective purge airflow through the respective first and second purge sectors.

According to an aspect, the regeneration sector angle is 60°, the first purge sector angle is 30° and the second purge sector angle is 30°. The sum of the first and second purge sector angles is equal to the regeneration sector angle when the regeneration sector angle is 60°, the first purge sector angle is 30° and the second purge sector angle is 30°. Together, the area of the regeneration sector and the sum of the areas of the first and second purge sectors are 180°, which is equal to the area of the process sector. Such a configuration of the regeneration sector, the first and second purge sectors and the process sector will generate air flows through the sectors, which allows for energy efficiency of the desiccant dehumidifier. Further, a stable, reliable and effective treatment of air is achieved.

According to an aspect, the purge airflow is configured to flow through the first purge sector in the opposite direction to the direction of the regeneration airflow through the regeneration sector. Such a configuration may result in an effective heat transfer from the desiccant rotor to the purge air, which flows through the first purge sector.

According to an aspect, the purge airflow is configured to flow through the first purge sector in the same direction as the direction of the regeneration airflow through the regeneration sector. Such a configuration may result in an effective heat transfer from the purge air to the desiccant rotor, which flows through the second purge sector.

According to an aspect, the first purge sector is arranged after the regeneration sector in relation to the rotational direction of the desiccant rotor. Thus, the desiccant rotor may first pass the regeneration sector in which the desiccant rotor is heated and regenerated. Thereafter, the desiccant rotor will enter the first purge sector, in which the temperature of the desiccant rotor is reduced by the purge airflow.

The desiccant dehumidifier will now be described together with the appended drawings.

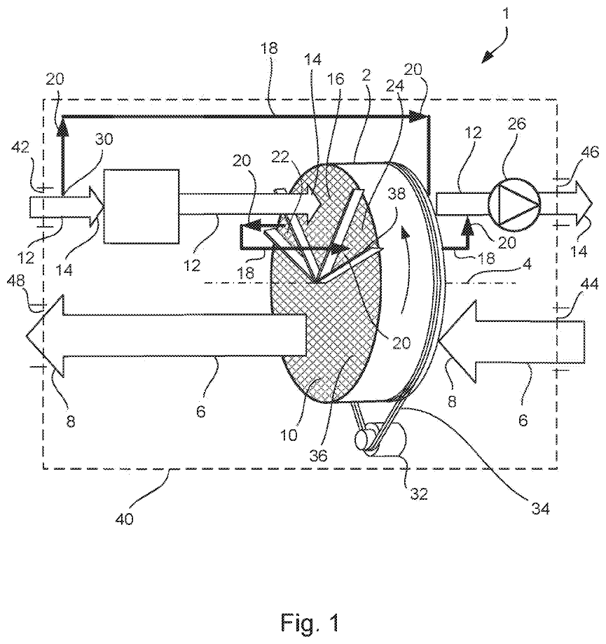

FIG. 1 schematically illustrates a view in perspective of a desiccant dehumidifier 1 according to an example. The desiccant dehumidifier 1 comprising a desiccant rotor 2, which is rotatably arranged about a centre axis 4 of the desiccant rotor 2. A process air circuit 6 is arranged to conduct a process airflow 8 through a process sector 10 of the desiccant rotor 2. A regeneration air circuit 12 is arranged to conduct a regeneration airflow 14 through a regeneration sector 16 of the desiccant rotor 2. A purge air circuit 18 is arranged to conduct a purge airflow 20 through a first purge sector 22 and a second purge sector 24 of the desiccant rotor 2. An air fan 26 arranged downstream of the desiccant rotor 2, which air fan 26 is configured to generate the regeneration airflow 14 in the regeneration air circuit 12 and the purge airflow 20 in the purge air circuit 18. The purge air circuit 18 is arranged to conduct the purge airflow 20 through the first purge sector 22 in a first direction through the desiccant rotor 2, and through the second purge sector 24 in a second direction through the desiccant rotor 2. The first direction is opposite to the second direction. The purge air circuit 18 is connected to the regeneration air circuit 12 downstream of the desiccant rotor 2. The purge air circuit 18 is connected to the regeneration air circuit 12 upstream of the desiccant rotor 2, and wherein the purge airflow 20 is configured to be collected from the regeneration airflow 14 in the regeneration air circuit 12. A heater device 28 is arranged in connection to the regeneration air circuit 12 upstream of the desiccant rotor 2 and downstream of a position 30 where the purge air circuit 18 is connected to the regeneration air circuit 12. A motor 32 is arranged to rotate the desiccant rotor 2 via a transmission 34. A process airflow 8 will pass a number of channels 36, which are arranged in the desiccant rotor 2. The channels 36 extend from one side to the other of the desiccant rotor 2. The channels 36 may be parallel to the center axis 4 of the desiccant rotor 2. The process airflow 8 pass the channels 36 in a first direction. The desiccant rotor 2 is adapted to treat the process airflow 8 by reducing water in the process airflow 8 that may pass through the channels 36 of the desiccant rotor 2. The desiccant rotor 2 comprises desiccant material, which is configured to extract moisture from the process air in the process airflow 8, so that the process air can leave the desiccant rotor 2 as dried air. The regeneration sector 16, the first and second purge sectors 22, 24 and the process sector 10 are configured by partition members 38, which may be arranged on both sides of the desiccant rotor 2. The partition members 38 may be fixed in the desiccant dehumidifier 1 or adjustable in relation to each other. The desiccant rotor 2 is configured to rotate in relation to the partition members 38. The desiccant rotor 2 and other components of the desiccant dehumidifier 1 may be accommodated into a housing 40, which is provided for inlet openings 42, 44 and outlet openings 46, 48.

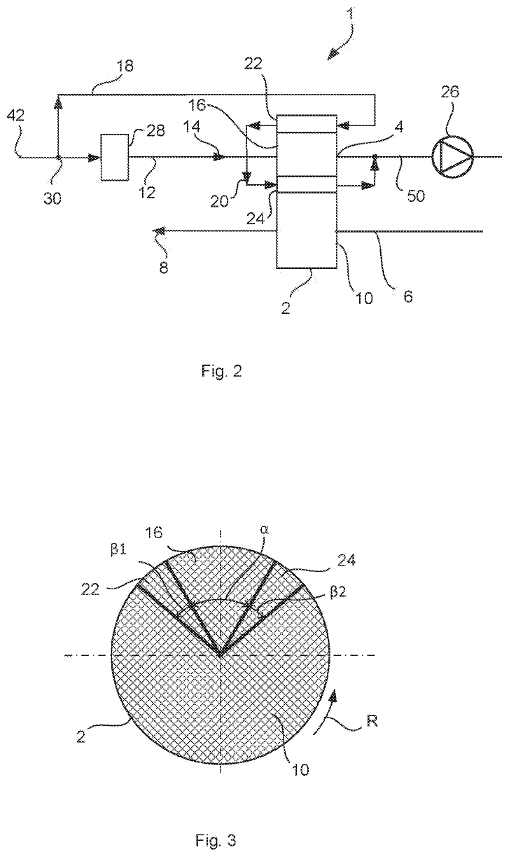

FIG. 2 schematically illustrates a desiccant dehumidifier 1 according to an example. The process airflow pass 8 the desiccant rotor 2 in a direction, which may be opposite to the direction of regeneration airflow 14 through the desiccant rotor 2. The regeneration airflow 14 and the purge airflow 20 have a common inlet 42. The purge air circuit 18 is connected to the regeneration air circuit 12 downstream of the heater device 28. Thus, the air from the inlet 42 will be divided into the purge air circuit 18 and the regeneration air circuit 12. After the purge air flow 20 and the regeneration airflow 14 have been separated from each other and have passed the desiccant rotor 2, they will be united into to a common channel 50 in which the air fan 26 is arranged. The purge air flow 20 and the regeneration airflow 14 will leave the common cannel 50 through the outlet 46.

FIG. 3 schematically illustrate a desiccant rotor 2 according to an example. The regeneration sector 16, the first and second purge sectors 22, 24 and the process sector 10 are configured by the partition members 38. The ratio between a regeneration sector angle α of the regeneration sector 16 and the sum of a first purge sector angle β1 and a second purge sector angle β2 of the respective first and second purge sector 22, 24 may be selected such that both the regeneration airflow 14 and the purge airflow 20 are generated (see FIG. 1). The first purge sector 22 is arranged after the regeneration sector 16 in relation to the rotational direction R of the desiccant rotor 2. During rotation, the desiccant rotor 2 will first pass the regeneration sector 16 in which the desiccant rotor 2 is heated and regenerated. Thereafter, the desiccant rotor 2 will enter the first purge sector 22, in which the temperature of the desiccant rotor 2 is reduced by the purge airflow 20.

The foregoing description of the embodiments has been furnished for illustrative and descriptive purposes. It is not intended to be exhaustive, or to limit the embodiments to the variations described. Many modifications and variations will obviously be apparent to one skilled in the art. The embodiments have been chosen and described in order to best explicate principles and practical applications, and to thereby enable one skilled in the arts to understand the invention in terms of its various embodiments and with the various modifications that are applicable to its intended use. The components and features specified above may, within the frame work of the disclosure, be combined between different embodiments specified.

1-13. (canceled)

14. A desiccant dehumidifier comprising:
a desiccant rotor, which is rotatably arranged about a center axis of the desiccant rotor;
a process air circuit arranged to conduct a process airflow through a process sector of the desiccant rotor;
a regeneration air circuit arranged to conduct a regeneration airflow through a regeneration sector of the desiccant rotor;
a purge air circuit arranged to conduct a purge airflow through a first purge sector and a second purge sector of the desiccant rotor;
an air fan arranged downstream of the desiccant rotor, the air fan being configured to generate the regeneration airflow in the regeneration air circuit and the purge airflow in the purge air circuit, wherein
the purge air circuit is arranged to conduct the purge airflow through the first purge sector in a first direction through the desiccant rotor, and through the second purge sector in a second direction through the desiccant rotor, the first direction being opposite to the second direction.

15. The dehumidifier according to claim 14, wherein the purge air circuit is connected to the regeneration air circuit downstream of the desiccant rotor.

16. The dehumidifier according to claim 14, wherein the purge air circuit is connected to the regeneration air circuit upstream of the desiccant rotor, and
wherein the purge airflow is configured to be collected from the regeneration airflow in the regeneration air circuit.

17. The dehumidifier according to claim 16, wherein a heater device is arranged in connection to the regeneration air circuit upstream of the desiccant rotor and downstream of a position where the purge air circuit is connected to the regeneration air circuit.

18. The dehumidifier according to claim 14, wherein the first purge sector is arranged adjacent to the regeneration sector on a first side of the regeneration sector, and the second purge sector is arranged adjacent to the regeneration sector on a second side of the regeneration sector.

19. The dehumidifier according to claim 14, wherein the ratio between a regeneration sector angle (α) of the regeneration sector and the sum of a first purge sector angle (β1) and a second purge sector angle (β2) of the respective first and second purge sectors is selected such that both the regeneration airflow and the purge airflow are generated.

20. The dehumidifier according to claim 14, wherein the ratio between a regeneration sector angle (α) of the regeneration sector and the sum of a first purge sector angle (β1) and a second purge sector angle (β2) of the respective first and second purge sectors is in the range of 1:1-1.5:1.

21. The dehumidifier according to claim 14, wherein the ratio between a regeneration sector angle (α) of the regeneration sector and the sum of a first purge sector angle (β1) and a second purge sector angle (β2) of the respective first and second purge sectors is in the range of 1:1-1.25:1.

22. The dehumidifier according to claim 14, wherein a regeneration sector angle (α) of the regeneration sector is equal to the sum of a first purge sector angle (β1) and a second purge sector angle (β2) of the respective first and second purge sectors.

23. The dehumidifier according to claim 22, wherein the regeneration sector angle is 60°, the first purge sector angle (β1) is 30° and the second purge sector angle (β2) is 30°.

24. The dehumidifier according to claim 14, wherein the purge airflow is configured to flow through the first purge sector in the opposite direction to the direction of the regeneration airflow through the regeneration sector.

25. The dehumidifier according to claim 14, wherein the purge airflow is configured to flow through the first purge sector in the same direction as the direction of the regeneration airflow through the regeneration sector.

26. The dehumidifier according to claim 14, wherein the first purge sector is arranged after the regeneration sector in relation to the rotational direction of the desiccant rotor.
